(19) United States
(12) Patent Application Publication
(10) Pub. No.: US 2008/0286159 A1
(43) Pub. Date: Nov. 20, 2008

(54) Variable Tube Diameter For SMR

(76) Inventor: Bhadra S. Grover, Sugar Land, TX (US)

Correspondence Address: AIR LIQUIDE;Intellectual Property, 2700 POST OAK BOULEVARD, SUITE 1800, HOUSTON, TX, 77056, US

(21) Appl. No.: 11/852,371

(22) Filed: Sep. 10, 2007

Related U.S. Application Data
(60) Provisional application No. 60/845,148, filed on Sep. 15, 2006.

(51) Int. Cl. B01L 3/00

(52) U.S. Cl. 422/102

(57) ABSTRACT

A catalyst tube is provided, that includes a bore, wherein said bore is adapted to contain a catalyst bed. The catalyst tube also includes a proximal end, wherein said proximal end has a first inside diameter, a first outside diameter, and a first wall thickness. The catalyst tube also includes a distal end, wherein said distal end has a second inside diameter, a second outside diameter, and a second wall thickness. The catalyst tube may be tapered, with a uniform wall thickness. The catalyst tube may have a uniform outside diameter, with a tapered inside diameter, and a non-uniform wall thickness. The catalyst tube may have a tapered outside diameter, a uniform inside diameter, and non-uniform wall thickness.

### CROSS REFERENCE TO RELATED APPLICATIONS

This application claims the benefit of U.S. Provisional Application No. 60/845,148, filed Sep. 15, 2006, the entire contents of which are incorporated herein by reference.

### BACKGROUND

Raw hydrocarbon fuel can be catalytically reformed into a synthesis fuel gas containing predominantly hydrogen and carbon monoxide. This synthesis fuel gas has many industrial applications. Often the hydrogen is separated from this synthesis fuel gas prior to being used in some industrial applications, such as fuel cells. The reforming of the raw fuel is typically performed in catalytic beds disposed in tubular containers that are enclosed in a reformer housing. The raw fuel, typically mixed with steam, will be fed into the reformer housing and into the catalyst beds, and the reformed fuel gas is drawn off of the catalyst beds and removed from the housing for transfer to downstream users. The reformer housing will also include a burner that heats the tubes and catalyst beds to operative temperatures for supporting this catalytic reaction.

In the larger applications, each reformer housing will contain a large number of catalyst tubes, all of which should be heated to the same extent for optimum reformer efficiency. These larger reformers will typically have a multiple burners to heat all of the catalyst tubes, so that a problem arises as to how all of the tubes in the housing will be heated to the optimum temperature. This problem of evenly distributing the heat from the reformer burner is a problem that must be addressed

Existing industrial practices invariably use tubes that have a uniform diameter and uniform thickness from the top to the bottom of the tube. The tube metal temperature varies along the length, being the hottest at the bottom nearest the burners, and coolest at the top. The required tube wall thickness is dictated by the hottest metal temperature that will be experienced. Thus there is invariably extra metal in the upper (colder) part of tube that is not technically necessary.

Since there is a temperature gradient along the length of the tubes, the heat flux likewise varies along the tube length. Normally the heat flux is highest at the end of the tube nearest the burner. For example, in a top fired furnace, heat flux at the top is about 50% higher than the heat flux at the bottom section of the tube. The uniform tube diameter along the whole length of the tube does not allow advantage to be taken of the higher flux in the top section.

### SUMMARY OF THE INVENTION

In one aspect of the present invention, a catalyst tube is provided. The catalyst tube includes a bore, wherein said bore is adapted to contain a catalyst bed. The catalyst tube also includes a proximal end, wherein said proximal end has a first inside diameter, a first outside diameter, and a first wall thickness. The catalyst tube also includes a distal end, wherein said distal end has a second inside diameter, a second outside diameter, and a second wall thickness. The catalyst tube may be tapered, with a uniform wall thickness. The catalyst tube may have a uniform outside diameter, with a tapered inside diameter, and a non-uniform wall thickness. The catalyst tube may have a tapered outside diameter, a uniform inside diameter, and non-uniform wall thickness.

### DETAILED DESCRIPTION

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

As used herein, the terms “substantially equal”, “substantially uniform” and “substantially constant” are defined as falling within industry recognized manufacturing tolerances, and ordinary and anticipated dimensional variations due to thermal growth and cycling.

In one embodiment of the present invention, an externally and internally tapered tube is used. The larger diameter may be used at the top (distal end) and smaller diameter may be used at the bottom (proximal end). The tube may have a substantially constant metal thickness being governed by minimum thickness required for the hottest section of the tube. The diameter of the distal end may be determined by evaluating the higher allowable stress value at the lower design temperature. This embodiment provides more total surface area for heat transfer, and more total catalyst volume, when compared to a traditional straight tube of uniform cross section.

In another embodiment, a tube with substantially uniform outer diameter (OD), but of varying metal wall thickness is used. This may provide the thinnest wall and largest inner diameter (ID) at the distal end, thereby providing more total catalyst volume. This embodiment provides more total catalyst volume, when compared to a traditional straight tube (i.e. non-tapered) of substantially uniform cross section and wall thickness. The heat transfer will also improve due to thinner tube (reduced wall thickness) at the distal end.

In another embodiment, a tube with substantially uniform inner diameter (ID), but of varying metal wall thickness is used. This may provide the thickest wall and largest outer diameter (OD) at the proximal end, thereby providing more mechanical strength to the tube. This embodiment provides approximately the same total catalyst volume, when compared to a traditional straight tube (i.e. non-tapered) of substantially uniform cross section and wall thickness, but greater mechanical strength.

Tapered tubes or varying metal wall thickness tubes may also serve to reduce the total number of tubes and total catalyst volume required for the SMR, thereby resulting in a smaller furnace.

What is claimed is:

1. A catalyst tube comprising;
a) a bore, wherein said bore is adapted to contain a catalyst bed,
b) a proximal end, wherein said proximal end has a first inside diameter, a first outside diameter, and a first wall thickness; and
c) a distal end, wherein said distal end has a second inside diameter, a second outside diameter, and a second wall thickness.

2. The catalyst tube of claim 1, wherein;
a) said first inside diameter and said second inside diameter are substantially equal,
b) said first outside diameter and said second diameter are not substantially equal, and
c) said first wall thickness and said second wall thickness are not substantially equal.

3. The catalyst tube of claim 1, wherein;
a) said first inside diameter and said second inside diameter are not substantially equal,
b) said first outside diameter and said second diameter are substantially equal, and
c) said first wall thickness and said second wall thickness are not substantially equal.

4. The catalyst tube of claim 1, wherein;
d) said first inside diameter and said second inside diameter are not substantially equal,
e) said first outside diameter and said second diameter are not substantially equal, and
f) said first wall thickness and said second wall thickness are substantially equal.
